(19) United States
(12) Patent Application Publication
(10) Pub. No.: US 2009/0064553 A1
(43) Pub. Date: Mar. 12, 2009

(54) Display Arrangement

(76) Inventor: Mats Gunnar Henrik Kroon, Anderstorp (SE)

Correspondence Address: DRINKER BIDDLE & REATH (DC), 1500 K STREET, N.W., SUITE 1100, WASHINGTON, DC, 20005-1209, US

(21) Appl. No.: 11/630,674

(22) PCT Filed: Jun. 22, 2005
(86) PCT No.: PCT/SE05/00986

§ 371 Date: May 21, 2008

(30) Foreign Application Priority Data
Jun. 28, 2004 (SE) 0401651-5

(51) Int. Cl. G09F 11/08

(52) U.S. Cl. 40/606.01

(57) ABSTRACT

The present invention relates to a display arrangement that includes a stand intended for securing a screen, where the stand includes a first part which supports against an underlying supportive surface, and a second part which extends up from the first part and whose upwardly extending end portion includes a first coupling device of a two-part coupling arrangement whose second coupling device co-acts with the screen, either directly or indirectly. The screen can be wounded up onto and unwounded from a bobbin located in a cavity in the first stand part, whereto with the bobbin can be actuated by a spring arrangement which is adapted to act on the screen in its fully wounded state around the bobbin with a chosen torque and/or chosen initial power or force (Fa-min). The active initial power generated by the spring arrangement can be generated by means of an elastic band that is twisted or rotated solely in one direction between its end portions, wherein said chosen initial power or force (Fa-min) relates to a large number of turns of the band, such as 100 turns.

### TECHNICAL FIELD OF THE INVENTION

The present invention relates generally to a display arrangement and, for instance, more particularly to a display arrangement that includes a readily collapsed and readily erected stand or a technically corresponding device, where the stand used can be adapted to secure a flexible information-presenting screen when in its erected state, and by flexible being meant that the screen can be rolled up onto and unrolled from a bobbin or a rod, normally in the form of a hollow-cylindrical body.

As a first application, the stand may include in this regard a first part that can be supported against an underlying supportive surface and a second part, or in special circumstances several second parts, that extends and/or extend upwards from the said first part.

The end portion of the second upwardly or outwardly extending part may conveniently include a first coupling element, included in a two-part coupling arrangement, whose other coupling element is given or related to an edge part, either directly or indirectly, normally an edge part that has been stiffened with the aid of a rail for co-action with said screen.

More particularly, it should be possible to roll the flexible information-presenting screen at least essentially tightly onto the bobbin or rod enclosed by the first part and correspondingly unwind the screen from said bobbin or rod, wherein rotation of the bobbin can be actuated by a torque generated by a spring arrangement so that the screen will be rolled up in more or less tight turns during a screen rolling or screen winding phase and against the action of a manually exerted force,

For example, it has been found that a stiffer screen requires a greater winding torque or power deriving therefrom, or more particularly from the spring force generated by the spring unit of a spring arrangement and a greater counterforce than that obtained in the case of a more elastic and softer screen in order to enable the screen to be wound tightly around the bobbin or the rod and therewith obtain a fully wound screen that can be accommodated in a cavity formed in a first stand part, such as a bottom part.

A spring arrangement and its associated spring unit utilized to this end in the case of the illustrated application is normally adapted to act on the screen with a progressively decreasing force during a screen wind-up phase and with a progressively increasing force on the screen during a screen unwinding phase; where the torque or a torque-derived force generated by the spring arrangement and its spring unit can be considered as a simple mathematic function that can be considered, more theoretically, as being directly proportional to an exposed screen section.

The spring arrangement is thus so adapted and regulated to act on the screen, with the aid of the spring unit, with a selected initial torque and/or a selected initial power related to a turning force when the screen is in a fully wounded state around the bobbin and enclosed in the cavity within the first part of the stand.

### BACKGROUND OF THE INVENTION

Several different methods and arrangements of the above-mentioned nature are earlier known to the art.

Generally speaking, a display arrangement of this kind or similar kinds can be conveniently divided functionally into two separate categories.

In a first category, the flexible screen located in a fully wound state on a bobbin or a rod within a cavity formed in an upper stand part is drawn from said part from above and downwards, with a function and a construction of a kind to be applicable to a “roller blind” although the screen shall be capable of being secured in its downwardly drawn position through the medium of a lower coupling means and associated coupling element and/or latched in this position through the medium of a bobbin-related latching mechanism.

In a second category of the display, arrangement, the flexible screen is drawn from a fully wound state on a bobbin from a lower first stand part in a direction from below and upwards thereby requiring a second stand-associated part, typically in the form of a collapsible or foldable rod that includes coupling means or coupling elements included in a coupling arrangement for securing the screen in its upper and extended state against the downward pulling action of the spring arrangement and the spring unit.

Both of these categories involve a spring unit adapted to the spring arrangement exerting a pulling force function (see FIG. 2) where the torque or the spring force deriving therefrom increases theoretically in proportion to the extent to which the screen is pulled-out or exposed.

In both of these categories the criterion can be achieved that the perceptible tension force, acting on the free edges of the exposed screen section, shall be constant, or at least essentially constant, during the entire withdrawal phase of the screen and its roll-up phase or sequence, and also during the entire roll-up phase or sequence.

However, the categories described above each require different conditions with regard to the dimensioning of the spring arrangement used and the construction of the spring unit related to said arrangement.

With regard to the first category of the display arrangement, the successively increasing weight of the successively exposed section of the screen will not compensate, neither fully nor partially, for the proportionally increasing value of the spring force in relation to the length of the screen section exposed at that moment in time independence on the weight of the screen material, but that the own weight of the exposed screen sections are able to create conditions for a tight winding of the screen about and around the bobbin used.

In the case of the second category of the display arrangement, the weight of the exposed screen sections will act as a further discernible pulling force or lifting force, depending on the extent to which the screen is exposed, said force being equal to the increasing value of the spring force in relation to the chosen extent to which the screen is exposed, wherewith the weight of the screen sections will be unable to create conditions for winding the screen around its associated bobbin.

In the case of the first category it is necessary to dimension the spring arrangement used and its associated spring unit to create a chosen perceivable tension force and to take up the weight of the screen with respect to the screen section exposed, and therewith achieve dimensioning of a power output function that will depend on the total weight of the screen in a fully extracted end position.

In the case of the second category totally different technical evaluations are required by virtue of the fact that the spring arrangement used and its associated spring unit shall be dimensioned to wind-up the whole of the exposed screen section sufficiently tightly around the bobbin used, wherewith dimensioning of the power output function will be determined essentially by the elasticity and thickness of the screen, and above all by the initial torque and/or power output that shall prevail, by definition, when the screen is fully wounded around the bobbin enclosed in the cavity located in the first stand part, where it rests against an underlying supportive surface.

The present invention relates primarily to a display arrangement, according to the second category, although it may also find convenient use in other types of display arrangements.

By way of a first example of the background of the technology and the technical field within the second category, to which the invention primarily relates, can be mentioned the display arrangement marketed by “Expand International AB, Stockholm, Sweden, under the designation “Expand QuickScreen”, wherewith the erection sequence of the display arrangement from a fully collapsed transport-adapted state to a fully erected state for presentation of a message or information applied to the flexible screen is illustrated in the accompanying drawing with reference to the erection sequences A-G, illustrated in FIG. 1.

The earlier known display arrangement utilizes a readily collapsible and readily erected stand, which includes a first part that supports against an underlying support surface and a rod-shaped second part that extends upwards from the first part, wherewith a flexible screen included in the display arrangement extends through a slot in the first part and can be wounded onto and unwounded from a bobbin which is enclosed in a cavity in said first part and which can be actuated by a spring arrangement having an associated spring unit.

The spring arrangement of the illustrated known display arrangement is based on the use of a spring unit, comprised of a metal wire that has been bent or twisted in a large number of turns into a helical shape, wherewith by virtue of its construction the spring unit is caused to act on the screen during a wind-up phase with a successively decreasing force, illustrated in the power (force) output function shown in FIG. 5 and acts on the screen with a successively increasing large force during an unwinding phase, also manifested in the power (force) output function.

Moreover, the spring arrangement is adapted so that when the screen is fully wounded around the bobbin, the spring unit will act on the screen with a chosen initial torque or torque-derived force, this force being adjusted to and chosen at a value of about 15 M (1, 5 kg) for practical reasons.

This known display arrangement encloses within its first stand-part a bobbin that has a diameter of 39 mm and includes an internal, partially cylindrical cavity having a diameter of 59 mm, wherewith the bobbin is able to rotate through 15 revolutions and therewith provide a maximum exposed screen section with a length or height of about 2200 mm.

The inclusion of a spring arrangement that includes a spring unit formed by a helically wounded metal wire is also known from the UK prior patent publication GB-A-2 267 988, which provides a function relating to the above-mentioned first category.

The use of a helical spring unit in a display arrangement comprising a flexible information-presenting screen is also known from the German Gebrauchsmusterregistration DE-U1-296 06 286.

With regard to the details associated with the present invention it can be mentioned that the international patent publication WO-A1-00/48164 illustrates and describes a portable and flexible display arrangement, where the exposed surface is intended to present print and also to illustrate drawings.

This international patent publication describes that the screen shall be capable of being unrolled from a rotatable axel (2) that is co-ordinated with a fixed support part when the screen in a roll-up state and in an initial position, in keeping with the conditions given with regard to the first category.

The information presenting surface can be drawn out manually from a cavity formed in said support part with the screen co-acting with an axel (2), thereby stretching and tensioning a spring arrangement so that the screen can be returned to its initial position with the aid of the energy thus added.

There is used in this case a spring arrangement that includes a spring unit in the form of a single stretched rubber band (8), wherewith the stretched rubber band (FIG. 4) has been given a rectangular cross-section and where a driving element (9) is provided in connection with the centre region of the rubber band.

The driving element (9) is adapted to tension the rubber band equally on respective sides thereof through the agency of rotary movement as the screen is pulled out, such as to store energy in the rubber band with the aid of said two-way rotation, thereby enabling the screen to return to its rolled up original state.

It is also mentioned in said publication (page 5, lines 12-14) that the rubber band (8) may be slightly twisted and stretched in an initial state of the screen so that an initially acting bias force can be created.

### SUMMARY OF THE PRESENT INVENTION

### Technical Problems

When taking into consideration the technical deliberations that a person skilled in this particular art must make in order to provide a solution to one or more technical problems that he/she encounters, it will be seen that it is necessary initially to realize the measures and/or the sequence of measures that must be undertaken to this end on the one hand, and on the other hand to realize which means is/are required to solve one or more of said problems. On this basis, it will be evident that the technical problems listed below are highly relevant to the development of the present invention.

When considering the earlier standpoint of techniques described above, it will be seen that a technical problem resides in the ability to realize the significance of, the advantages associated with and/or the technical measures and deliberations required in enabling the earlier known spring unit, comprised of a helically wounded, multi-turn twisted metal wire or bent metal band in a construction relating to and adapted to one or both of the above-mentioned categories of a display arrangement, and then particularly the second category/to be replaced with an elastic band, that is twisted or rotated equally along the whole of its length, and to realize the dimensioning rules that are predominant in respect of such an application.

It will also be seen that a technical problem resides in realizing the significance of, the advantages associated with and/or the technical deliberations that must be taken in permitting the spring arrangement used and its associated spring unit to have with regard to said built-in spring unit a power output function that has a smaller spring constant than that of the helically wounded and twistable metal wire, therewith providing a smaller power increase or torque increase in respect of a large expense of exposed screen section or a fully exposed screen.

A further technical problem resides in the ability to realize the significance of, the advantages afforded by and/or the technical measures and deliberations required in enabling the creation of the initial power or initial torque achieved by said spring arrangement and its associated spring unit to be created by a thus twisted or rotated elastic band, such as a rubber band, and in relating the initial power or force to a chosen number of turns of the elastic band.

Another technical problem resides in realizing the significance of, the advantages associated with and/or the technical measures and deliberations required in dimensioning the elastic band and its elastic modulus so that the band can be rotated or twisted in a relatively large number of turns, so as to achieve said initial power, and that the number of turns shall be placed in relation to the number of turns required to fully roll-up a fully expose sections of the flexible screen, where the latter number of turns can, in practice, be less than 20, although normally above 10, such as about 15, and therewith ensure a proportional increase and/or an adapted small decrease of the spring force and the torque.

Another technical problem resides in realizing the significance of, the advantages associated with and/or the technical measures and deliberations that will be required in utilizing the elasticity of rotated or twisted elastic band and in choosing an elastic region of a chosen elastic material, such as a rubber material, that corresponds to or shall take-up the number of turns required to roll-up and unroll the maximal length of the flexible screen, said regions being capable of withstanding a large number of stresses, such as force increases and force decreases, within given chosen limits.

A technical problem also resides in the ability to realize the significance of, the advantages associated with and/or the technical measures and deliberations in enabling the elastic band to be twisted or rotated through a number of turns at which said initial power or force will be achieved through the medium of its elasticity, such as between 80 and 160 turns, e.g. between 110 and 140 turns.

Another technical problem resides in the ability to realize the significance of, the advantages associated with and/or the technical measures and deliberations required in allowing the initial torque and the torque-deriving force acting on the screen to be chosen at between 8 and 20 N solely by choosing the number of turns around which the elastic band or bands used is/are rotated.

Another technical problem resides in the ability to realize the significance of, the advantages associated with and/or the technical measures and deliberations required in allowing the torque and the torque-deriving force acting on the screen in a chosen fully unwounded state of the screen to be chosen at a value which only slightly exceeds said initial power or force, such as between 30 and 40 N at the highest.

Another technical problem resides in the ability to realize the significance of, the advantages associated with and/or the technical measures and deliberations which must be made in order to allow the spring arrangement to include at least one rod and at least one elastic band, which is twisted or rotated in one and the same direction and which acts as a spring unit between the end portions of said rod, wherein one end portion of the elastic band is adapted for easy application to but fixed co-action with said rod, and wherein the other end portion of the elastic band is adapted for easy application to but in fixed co-action with a hook or corresponding band-fastening element.

Another technical problem resides in the ability to realize the significance of, the advantages associated with and/or the technical measures and deliberations required in allowing the band-loaded spring unit of the spring arrangement to be concentrically related to and disposed within said bobbin, provided in the form of a hollow cylinder.

Another technical problem resides in the ability to realize the significance of, the advantages associated with and/or the technical measures and deliberations required in allowing the elastic modulus of said elastic band and the thickness of said band to be given values that are well adapted to chosen functionalities relating to the application and the category concerned.

A technical problem also resides in the ability to realize the significance of, the advantages associated with and/or the technical measures and deliberations required in order to allow the elastic band or bands to be given a more or less circular cross-section, so as enhance the mechanical strength of said band/bands.

It will also be seen that a technical problem resides in realizing the significance of, the advantages associated with and/or the technical deliberations required in allowing each of said elastic band to be structured as one or more co-ordinated endless flexible bands.

### Solution

The present invention is thus based on the known technology defined in the introduction and described in more detail by way of example in the following text with reference to FIG. 1, although while taking into account the contents of the international patent publication WO 00/48164 that teaches a display arrangement according to a first category that includes a spring arrangement having a spring unit comprised of elastic material, such as rubber material or elastomeric material according to the above definition, wherein a stand shall be capable of being adapted to firmly secure a soft and/or elastic screen that displays information and that is stretched by a spring arrangement and its associated spring unit, wherein the stand may include in a chosen application a first part which rests against an underlying supportive surface and that includes at least one rod-shaped second part extending up from the first part wherein the upwardly extending end portion of said second part will be capable of having or exposing a first coupling device, included in a two-part coupling arrangement, whose other, corresponding coupling device may co-act with said screen either directly or indirectly.

The screen shall be capable of being wound onto and unwound from a cavity-enclosed bobbin in a first part of the stand, wherewith the bobbin can be rotated through the medium of a spring arrangement and a spring unit related thereto.

The spring arrangement and its spring unit are constructed to act on the screen with a decreasing torque and torque-derived force during a winding-up phase and to act on the screen with an increasing torque and a torque-derived force during an unwinding phase, wherein when the screen is fully wounded around the bobbin the spring arrangement functions to act on the screen with a small initial torque and/or force selected through the construction of the spring unit.

With the intention of solving one or more of the aforesaid technical problems, it is proposed, in accordance with the invention/that the known technology shall be supplemented by enabling the initial power or force of the spring arrangement and its associated spring unit to be generated by an elastic band, which can be rotated or twisted between its ends solely in one direction (or another) and which functions as its spring unit, and that said chosen initial power or force shall be related to a chosen number of turns of the elastic band.

By way of proposed embodiments that lie within the scope of the basic concept of the invention it is proposed that the elastic band is rotated a large number of turns, in relation to the number of turns required to roll up all of the exposed screen or to roll up the entire screen. In this regard, the elastic band may be rotated between 80 and 160 turns, such as between 110 and 140 turns.

It is also proposed that the initial torque acting on the screen and the torque-derived force shall be between 8 and 20 N.

It is also proposed that when the screen has been unwounded fully, the force acting on the screen will be small, such as between 30 and 40 N at the most.

It is also proposed that the spring arrangement shall include at least one rod and at least one spring unit turning element or rotated elastic band, whose one end portion is intended for co-action with said rod and the other end portion of which is adapted for co-action with a hook or the like securing device.

It is proposed in particular that the rod and the spring unit, belonging to the spring arrangement, shall be concentrical with the bobbin, formed as a hollow cylinder.

The elastic modulus (Young's modulus) of the elastic band and the thickness of said band shall be chosen appropriately with regard to the aforesaid object of the invention and its application. According to the invention, the elastic band may have a circular cross-section.

### Advantages

Those advantages that can be considered particularly characteristic of the present invention, and the special significant characteristic features of the invention, reside in the provision of conditions which enable a display arrangement, such as a second category display arrangement to be provided with a spring arrangement which can be produced much more cheaply than the known spring arrangement, which uses a spring unit consisting of a helically wound metal material, in addition to providing a power or force output function with a shallower or less steep line or gradient representing the increasing torque or torque-derived force that will act on a screen during a screen unwinding phase and vice versa, by allowing the spring unit of the spring arrangement to comprise one or more bands, which may conveniently be endless, in the present case illustrated as rubber bands of different categories, wherein said chosen initial power or force will be related to a chosen number of turns for tensioning the elastic band or elastic bands between its/their attachment points.

In the illustrated case, the spring unit is comprised of one or more endless elastic bands which are stretched or tensioned by rotation between two attachment points, wherewith the stored and/or dispensed energy is created by equal twisting or rotation of the elastic band or bands between said attachment points and in one and the same direction.

The primary characteristic features of the present invention are set forth in the characterizing clause of the accompanying claim 1.

### BRIEF DESCRIPTION OF THE DRAWINGS

An earlier known display arrangement of said second category and comprising a spring arrangement, having a spring unit comprised of a metal wire, and located in a first lower part of a stand, and an embodiment of a spring arrangement at present preferred and suggested and including a spring unit that is comprised of one or more elastic bands and has significant characteristic features associated with the present invention will now be described more clearly by way of example with reference to the accompanying drawings, in which;

FIG. 1 illustrates assembly sequences A-G, applicable to an earlier known display arrangement having a construction according to a second category;

FIG. 2 is a diagrammatic illustration of a known first display arrangement constructed in accordance with a first category, and also illustrating a side-related and side-orientated known second display arrangement, having a construction according to a second category, and also illustrating torque-extraction-functions, or rather power or force output functions related thereto, while taking into account the natural weight of an exposed screen section among other things;

FIG. 3 is a partially sectioned perspective view of a spring arrangement constructed in accordance with the principles of the invention wherein a spring unit comprised of one or more rubber bands is shown in a tight tension-force exerting state representative of the case when a screen is fully unwounded;

FIG. 4 is a partially sectioned perspective view of a spring arrangement, constructed in accordance with the principles of the invention, showing a spring unit comprised of one or more rubber bands in a state representative of the case when the screen is fully wounded around the bobbin; and

FIG. 5 illustrates different power or force output functions representing different torque or force diagrams, where the illustrated active force is obtained from a number of different spring arrangements, that include spring units formed by one or more elastic bands, in accordance with the invention, where said illustrated functions are related to the extent to which the screen has been unrolled or withdrawn and the number of turns to which the rubber band/bands has/have been subjected or twisted.

### DESCRIPTION OF KNOWN TECHNOLOGY

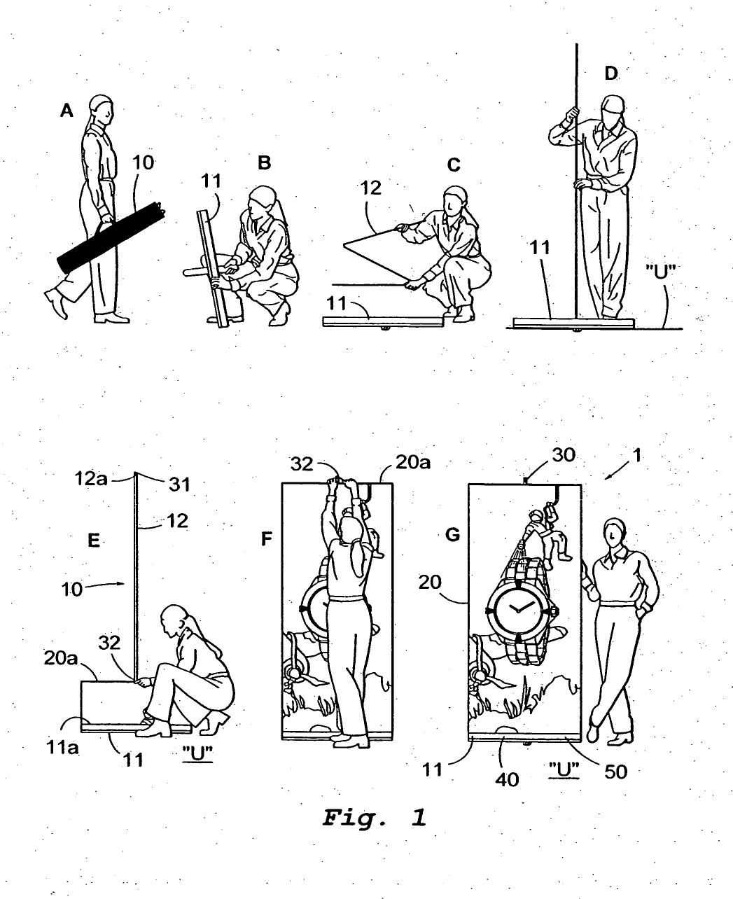

FIG. 1 thus illustrates a more or less complete assembly sequence with the aid of individual assembly steps referenced A-G of a display arrangement 1 constructed in accordance with the conditions given in the introduction with regard to a second category, this assembly sequence or erection sequence also being applicable to a chosen embodiment according to the invention.

According to step A, the inventive display arrangement 1 includes a stand 10, which in a fully erected state (steps F, G) firmly supports a screen 20, wherewith the stand 10 includes a first part 11 which supports against an underlying supportive surface U (step D), and further includes a foldable part 12 which, when the stand is erected, extends upwardly from the first part 11.

One upwardly extending end part 12a of the second part 12 (step E) has a first coupling element 31 included in a two-part coupling arrangement 30, wherewith the other coupling element 32 of the coupling arrangement is joined to the screen 20 either directly or indirectly, and orientated in connection with the upper edge part 20a of the screen.

The screen 20 can be wounded onto and unwounded from a bobbin (not shown) enclosed in a cavity (not shown) located in the first part 11, wherein the bobbin can be actuated by a spring arrangement (not shown) that includes an associated spring unit.

The bobbin or the rod has been referenced 40, whereas the spring arrangement used has been referenced 50 and in the illustrated case is included as part of the known technology, described in the introduction.

This spring arrangement 50 is designed to act on the screen 20 with a decreasing force during a screen wind-up phase (the sequences or the steps from F to E) with the aid of a spring unit consisting of a helically twisted or wounded metal wire, wherewith the screen 20 is acted upon at an increasing force during an unwinding phase (the sequences or steps from E to F), where the later force division in a power output function is shown and described with reference to FIG. 5 by way of comparison.

The spring arrangement 50 is also adapted to act on the screen 20 with a chosen initial power when the screen 20 has been fully wounded around the bobbin 40 (in accordance with sequence D).

The first stand part 11 includes a slot 11a through which the screen passes so as to be unwounded from or wounded onto the bobbin present in said cavity.

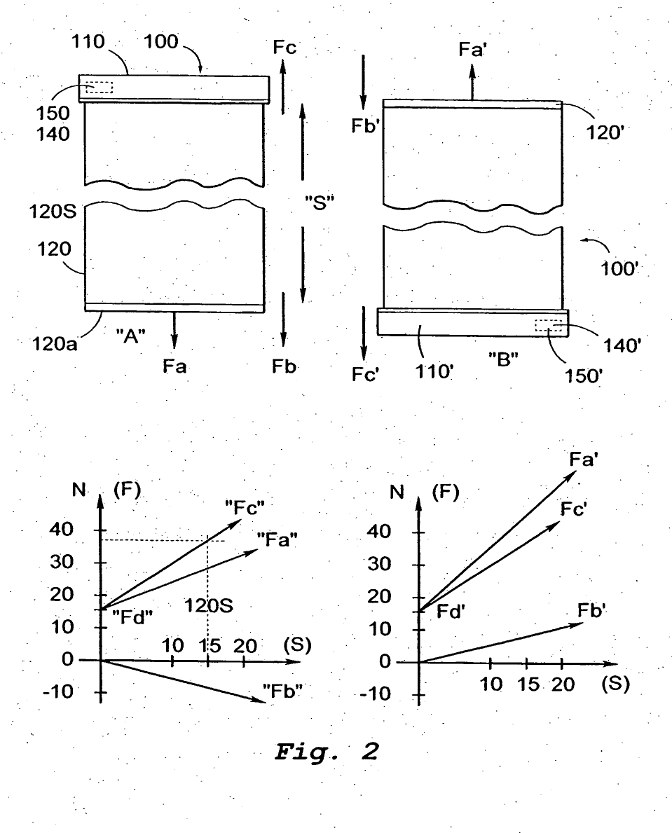

FIG. 2 illustrates a known first display arrangement 100 constructed in accordance with a first category (to the left of the figure), and further illustrates a known second display arrangement 100′ constructed in accordance with a second category (to the right of the figure), wherein the figure also illustrates the respective category-related power output function while observing somewhat diagrammatically the own weight of the exposed screen section.

More particularly the active torques achieved with the illustrated power or force output functions and with the aid of the spring units have been transformed to respective powers or forces while observing the force generated by the intrinsic weight of an increasingly exposed screen section, whereby the operator can manually discern and overcome the tension force.

Thus, there is shown to the left of FIG. 2 a first display arrangement 100 relating to a first category, where an upper stand unit 110 includes a bobbin 140 on which there acts a torque or a force from a known spring arrangement 150 that has an associated spring unit.

The reference Fa indicates the increasing (or decreasing) force acting on the screen edge 120a grasped by the operator's hand when drawing a screen section S from the upper stand part or stand unit 110 during a screen unrolling sequence, or when said screen section is wound up onto a bobbin 140 within the stand part or stand unit 110 in a screen roll-up sequence.

The reference Fb is intended to indicate the force or forces that are exerted from the spring arrangement 150 used.

The power output functions concerning the forces Fa, Fb and Fc are here illustrated as being proportional to the extent to which the screen S is withdrawn. In a practical application of the invention, it may be that the power output function will deviate from the proportionality approximated here.

It will be obvious that the inclination or gradient of the force arrow Fb will be greater with heavier material in the screen 120 and that greater compensation can be afforded with respect to the power arrow Fc in order to obtain a more horizontal power arrow Fa.

It lies within the realm of possibilities to provide full compensation for the powers Fb and Fc and therewith obtain a constant power Fa that is fully independent of the length of the screen section S exposed.

As a function of the exposed screen section S, the force Fb begins at the zero-point, whereas the powers Fa and Fc begin at a chosen initial power or force, here referenced Fd.

It will be apparent from this that the weight of a screen section 120S exposed to a maximum is chosen as 8 N (0,8 kg) at S=15, although it will be understood that a stronger or thinner screen material can be used.

It will also be apparent that the power or force output function Fc of the spring arrangement exerts an initial power or force of ISM (S=0) and a power or force of 38 N at S=15.

It is not unusual for known spring arrangements 150 to provide power or force output functions that have greater gradient coefficients than the illustrated gradient coefficient, depending on the number of turns of the steel wire threads and their thickness.

Shown correspondingly to the right on the figure is a second display arrangement 100′ of a second category, where corresponding powers or forces have been given corresponding reference signs, supplemented with a “prime”-characteristic, such as Fa′ and Fb′, Fc′ and Fd′, although it will be noted that the powers or forces Fb′ and Fc′ act in mutually the same direction wherewith it will be noted that in the case of this embodiment the need for a flatter line (more horizontal) with regard to the power or force Fa′ becomes more relevant with respect to lifting the screen edge 120a′ and lowering the screen from and rolling the screen onto the bobbin 140′ under the action of the spring arrangement 150′ located in the lower stand unit 110′.

The present invention will therefore find a more preferred application in the second category of the display arrangement 100′, since the power or force Fc or, alternatively Fc′, will be afforded a smaller gradient coefficient in accordance with the invention.

### DESCRIPTION OF EMBODIMENTS AT PRESENT PREFERRED

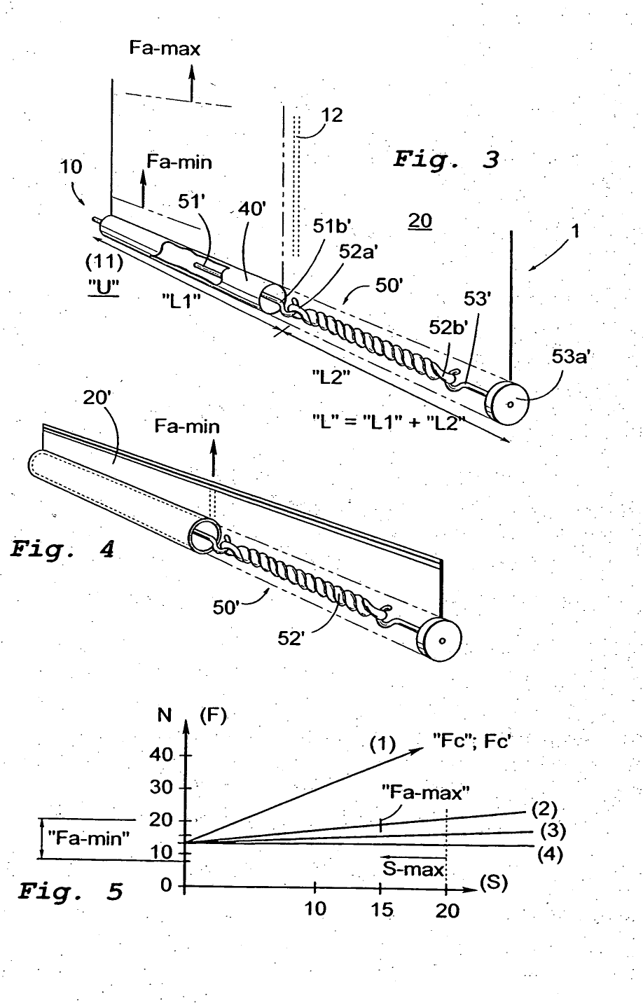

It is pointed out initially that we have chosen to use in the following description of an embodiment which is at present preferred and which includes significant characteristic features of the invention and illustrated in FIGS. 3 to 5 inclusive in the accompanying drawings special terms and terminology with the intention of illustrating the inventive concept more clearly. However, it will also be noted that the expressions chosen here shall not be seen as being limited solely to the chosen terms used in the description but that each term chosen shall be interpreted as also including all technical equivalents that function in the same or at least essentially in the same way so as to achieve or expose the same or essentially the same purpose and/or technical effect.

With reference to FIGS. 3 and 4, which illustrate the basic requirements of the present invention diagrammatically and show the significant characteristic features of the invention, the invention will be described more concretely with reference to an exemplifying embodiment thereof.

As an example, FIG. 3 is a diagrammatic illustration of a spring arrangement 50′ constructed in accordance with the invention, where the spring arrangement includes at least one rod 51′ and a preferably endless elastic band 52′ which is twisted or rotated along its axis, where a first end part 52a′ of the band is intended for co-action with a second end portion 51b′ of the rod 51′ and a second end portion 52b′ of the elastic band is intended to be secured to a hook 53′ or a technically equivalent device.

The hook 53′ co-acts with an end wall 53a′ that is adapted for rotation of the bobbin.

The chosen number of turns around which the elastic band 52′ is twisted or rotated according to FIG. 3 and the number of turns to which the same elastic band 52′ is twisted or rotated according to FIG. 4 shall be adapted to suit different criteria and different applications, as will be explained more specifically hereinafter with the selected number of turns according to FIG. 3 being somewhat greater than the number of turns selected in accordance with FIG. 4.

Thus, it lies within the scope of the present invention to use one or more elastic bands 52′, which may have mutually the same or mutually different thicknesses.

The elastic bands 52′ may consist primarily of natural rubber that has been treated in different ways, where produced crude rubber includes the organic compound “Isoprene” that is typically mixed with additives such as sulphur.

The elastic bands may also consist of synthetic rubber, where the raw material is most often petroleum treated in a known manner.

Those persons skilled in this art may choose methods of producing and/or treating these two rubber materials so as to obtain a chosen elasticity, thickness, etc. that will provide maximum properties with each chosen application, although other elastic materials may also be chosen.

For the sake of simplicity, the elastic band or bands used will be exemplified as rubber bands in the following description.

A fundamental evaluation lies in twisting (rotating) a rubber band or bands to provide an adaptive torque or tension force Fa-max at a fully extracted or withdrawn state, such as an unrolled state of the screen 20 (FIG. 5, S=15) wherewith said torque or force shall correspond to or be only slightly smaller than the torque or tension force Fd′ (Fa-min) applicable to the initial power when the screen 20 is in a fully wounded state (FIG. 5, S=0).

If the initial power Fa-min is chosen as 15 N (see FIG. 5) the maximized tensioning power or force Fa-max shall reach at most 30 N or less, although other values may be chosen according to the application concerned, as will be understood.

The powers or forces Fa-min and Fa-max in FIG. 5 are manually related forces with no compensation for the weight of the screen section 20.

A given initial number of turns of the rubber band or rubber bands 52′ are required to achieve the initial power or force Fa-min, whereas the power or force Fa-max is obtained with additional turns, say from 15 to 20 turns, i.e. in the case of a fully withdrawn screen section S-max which is assumed to lie between 15 and 20 turns.

It can be ascertained in principle that the torque or the initial power or force Fa-min transposed to Fa-max is a linear function of the number of turns, wherewith a chosen few turns of the rubber band in achieving the initial power or force Fa-min will result in a relatively high value at the power or force Fa-max, i.e. the linear equation for the power or force Fa-min up to Fa-max will have a gradient coefficient or directional coefficient which is greater than the coefficient that would be applicable should a much larger number of turns be chosen to achieve the power or force Fa-min although with the same number of turns 15-20 for extending the exposed screen section S to a maximum with regard to the value chosen for the force S-max.

A person skilled in this art would be able to choose an appropriate elastic material on the basis of these criteria, so that the chosen thickness and its elastic modulus would fulfil said requirements.

In other words, in the case of a stiffer and thicker rubber material the initial power Fa-min can be achieved with a few turns although with this selection the power or force increase per turn (S) above this few number of turns will be significant and can result in a power or force increase per turn that will even exceed that applicable to the known technology according to FIG. 2.

A softer and thinner rubber material requires a far greater number of turns in order to achieve the initial power Fa-min, meaning that the power or force increase for each turn in excess thereof will be small and can result in a power or force increase per turn to Fa-max which can be adjusted solely by virtue of the number of turns selected.

Under these conditions it has been found suitable in respect of a number of applications to choose an elastic material whose elasticity, dimensions and/or thickness with which the initial power or force Fa-min requires between 80 and 160 turns, such as between 110 and 140 turns, presuming an equal rotational movement between the mutually opposite ends 52a′ and 52b′ of the rubber band 52′.

In the FIG. 5 embodiment the initial power Fa-min acting on the screen 20′ is between 8 and 20 N, such as the known value 15 N, by virtue of the number of turns chosen and the structure of the rubber band 52′.

The power or force, for instance Fa-max, acting on the screen 20, when the screen is fully unwounded, shall be relatively small, such as between 30 and 40 N or lower.

It will be seen particularly from FIGS. 3 and 4 that the spring arrangement 50′with associated rod 51′ and rubber band 52′ is related concentrically to the bobbin 40′, which has the form of a hollow cylinder that extends across the full width of the screen 20′.

The thickness of the rubber band 52′ and its modulus of elasticity are both given values appropriate to the application chosen in this regard.

It may happen that the number of turns required in respect of one or more rubber bands 52′ in FIGS. 3 and 4 may be relevant in respect of a particular application but is not representative of the different turns required in reality and under different conditions.

It will be noted in particular that the rubber band 52′ may have a circular cross-section instead of a rectangular cross-section, with the aim of enhancing the mechanical strength of the rubber band.

However, there is nothing to prevent the use of an elastic band 52′ of some other structure by way of an alternative, such as the use of a band or a line that includes mutually rubber bands as a core, with said bands being contained in a braided plastic stocking.

FIG. 4 is a partially sectioned diagrammatic illustration of a spring arrangement 50′ constructed in accordance with the principals of the invention, and shows a spring unit comprised of a rubber band 52′ in a chosen position representative of when a screen 20′ has been wounded fully onto the bobbin.

FIG. 5 shows different force diagrams representative of different power or force output functions, where;
a first line (1), which represents an earlier known spring arrangement (according to FIGS. 1, 2 and 3) that has a spring unit comprised of a helically wound or twisted metal wire;
a second line (2), which represents a spring unit that has two endless rubber bands wounded 50 turns, to provide an initial power or force of 15 N;
a third line (3), which represents a spring unit that includes six endless rubber bands wounded 100 turns, to provide an initial power or force of 15 N;
a fourth line (4), which represents a spring unit that has two rubber bands wounded 150 turns to provide an initial power or force of 15 N.

It will be evident that the illustrated spring arrangements and associated spring units comprised of rubber bands that have been twisted or rotated differently and that have mutually different cross-sections and elastic modular or afford different power or force output functions (F/S-functions) which are mutually divergent in principle and have mutually different gradient coefficients for different turns in order to achieve the initial power (Fa-min) wherewith the downwardly acting power or force Fa-max in the sequence F shown in FIG. 1 can be adjusted to a lower and more comfortable value than in the case of a twisted metal wire.

The invention also affords a further possibility of adjusting or controlling the powers or forces Fa-min to Fa-max by virtue of enabling the total length L of the first part 11 (or the width of the screen 20) to be divided into two fictive parts L1 and L2, a first part L1 assigned to the rod 51′ and a second part L2 assigned to the rubber band or several co-ordinated rubber bands 52′ used.

By adapting the relationship between the two fictive parts L1 and L2, the length of the rubber band between its attachment points 52a′ and 52b′ can be varied in correspondence to the varying power output functions and the choice of the number of turns in achieving the initial power.

FIG. 3 illustrates different lengths of respective parts L1 and L2 and it will be evident therefrom that in practice the maximum ratio should not exceed 1:4.

It will be understood that the invention is not restricted to the above exemplifying embodiments but that modifications can be made within the scope of the inventive concept, as illustrated in the accompanying claims.

It will be observed that each illustrated unit and/or circuit can be combined with each other illustrated unit and/or circuit within the framework of being able to achieve the desired technical function.

1. A display arrangement that includes a stand adapted to secure a screen, wherein the stand includes at least one part, wherein the screen can be wounded onto and withdrawn from a bobbin enclosed in a cavity in said one part, wherein the bobbin can be actuated by a spring arrangement adapted to act on the screen with decreasing power or force during a screen wind-up phase and with increasing power or force during a screen unwinding phase, and wherein, when the screen is in its fully wounded state around the bobbin, the spring arrangement acts on the screen with a chosen initial power or force, wherein the initial power or force generated by the spring arrangement can be generated by an elastic band rotated or twisted solely in one or another direction between its end portions; and in that said chosen initial power is related to a selected large number or turns of the elastic band in relation to the number of turns required to unwind or roll-up a maximum length of an exposed screen.

2. A display arrangement according to claim 1, wherein the number of turns of the elastic band is adapted to between 80 and 160, such as between 110 and 140.

3. A display arrangement according to claim 1, wherein the initial power or force active on the screen is chosen to between 8 and 20 N.

4. A display arrangement according to claim 1, wherein the power acting on the screen is chosen between 30 and 40 N in the case of the fully unwounded screen.

5. A display arrangement according to claim 1, the spring arrangement includes at least one rod and one twisted or rotated elastic band whose one end portion is intended for co-action with said rod and its other end portion is adapted for co-action with a hook or corresponding device.

6. A display arrangement according to claim 1, wherein the spring arrangement includes a rod and at least one elastic band arranged concentrically in relation to said bobbin in the form of a hollow cylinder.

7. A display arrangement according to claim 1, wherein the thickness of the elastic band and its modulus of elasticity is chosen to correspond to a given application.

8. A display arrangement according to claim 1, wherein the elastic band has a circular cross-section.

9. A display arrangement according to claim 1, wherein a band and/or a plurality of bands comprise an endless band.

10. A display arrangement according to claim 5, wherein the rod has a length that corresponds to the distance between the mutually opposite end portions of the elastic band with a given ratio.

11. A display arrangement according to claim 1, wherein the elastic band has the form of a rubber band.

12. A display arrangement according to claim 11, wherein the rubber band is comprised of a treated natural rubber material.

13. A display arrangement according to claim 5, wherein the spring arrangement includes a rod and at least one elastic band arranged concentrically in relation to said bobbin in the form of a hollow cylinder
